(19) United States
(12) Patent Application Publication
(10) Pub. No.: US 2009/0021350 A1
(43) Pub. Date: Jan. 22, 2009

(54) Portable electronic device, security system and method for determining allowable operating range of portable electronic device

(75) Inventors: Koichi Hatta, Gumma (JP); Noritaka Koyama, Tokyo (JP); Yasuhiro Mitsui, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD, Tokyo (JP)

(21) Appl. No.: 11/919,129

(22) PCT Filed: Apr. 18, 2006
(86) PCT No.: PCT/JP2006/308132

§ 371 Date: Oct. 24, 2007

(30) Foreign Application Priority Data
Apr. 28, 2005 (JP) 2005-132332

(51) Int. Cl. H04Q 5/22

(52) U.S. Cl. 340/10.1

(57) ABSTRACT

There is provided a portable electronic device limiting an allowable operating range thereof for security reason and a security system using the portable electronic device. A security system 10 includes a mobile-phone 100 and an item 101. The mobile-phone 100 has functions of a registering unit 501, a judging unit 503 and an operating range determining unit 504, etc. The registering unit 501 registers item information to specify the item in advance. The judging unit 503 judges, based on the presence or absence of a signal from the item, whether an item specified by the registered item information can communicate with the mobile-phone or not when an event is generated in the mobile-phone. When it is judged that the communication is possible, the operating range determining unit 504 allows a normal operation of the mobile-phone in response to an external access, and when it is judged that the communication is impossible, the operating range determining unit 504 limits the operating range of the portable electronic device in response to an external access.

### BACKGROUND OF THE INVENTION

1. Field of the Invention

The present invention relates to a portable electronic device determining an allowable operating range thereof, a security system using the portable electronic device and a method for determining an allowable operating range of the portable electronic device.

2. Description of the Related Art

In recent years, a number of systems for providing a desired service to a mobile terminal have been realized by the communication between a portable electronic device (hereafter, referred to as “mobile terminal”) and a device on a service provider's side (for example, refer to Patent Document 1). In addition, a company salesperson, traveler and so on conduct business by using a mobile terminal from the visit outside company to access in-company system, which is becoming common. In such a system, the mobile terminal is distributed to each employee and the employee goes out having the mobile terminal in which stored in-company information in advance or access in-company system after authenticating by a password, etc. as required, by which a business is achieved.

### [Patent Document 1] Japanese Patent Laid-open Publication No.

### SUMMARY OF THE INVENTION

However, using a mobile terminal for business in the recent style, the critical information in company is kept being stored even when the mobile terminal is carried after office hours. In the recent system style, for this reason, there is increased the risk of leakage of corporate confidential information, personal information on clients due to leaving, loss or robbery.

In the case of sloppy password management (for example, a password can be easily guessed or a password is written down), when the authentication can be normally achieved by impersonation, even other persons can access to the in-company system. In the authentication method according to the recent system, for this reason, there is an increasing risk of the leakage of corporate confidential information, personal information on clients. According to the recent information networking, further, it is not too much to say that the risk of information leakage in company is increasing very much with the use of mobile terminal as such.

The present invention has been achieved in view of the aforementioned issues. An object of the present invention is to provide a portable electronic device limiting an allowable operating range thereof to enhance a security, a security system using the portable electronic device and a method determining an allowable operating range of the portable electronic device.

According to an aspect of the present invention, to solve at least one of the aforementioned issues, there is provided a portable electronic device radio communicating with an item as a possession other than the portable electronic device owned by an owner of the portable electronic device.

More specifically, the portable electronic device includes a registering unit for registering item information to specify the item in advance in memory, a judging unit for judging, based on the presence or absence of a signal from the item, whether an item specified by the registered item information can communicate with the portable electronic device or not when an event is generated in the portable electronic device; and an operating range determining unit.

The operating range determining unit allows a normal operation of the portable electronic device in response to an external access when the judging unit judges that the item can communicate with the portable electronic device and limits the operating range of the portable electronic device in response to an external access when it is judged that the item can not communicate with the portable electronic device.

Here, “the item can not communicate with the portable electronic device” means that the portable electronic device cannot recognize the item as a possession other than the portable electronic device, in other words, the owner is not near the portable electronic device. In addition, when the portable electronic device is left or stolen, the item cannot communicate with the portable electronic device. In such a case, according to the present invention, the allowable operating range of the portable electronic device changed according to an external access (for example, the user of the portable electronic device operates the portable electronic device) is limited to be narrower than a normal allowable operating range. Thereby the operation of the portable electronic device can be allowed or limited according to the “presence or absence” of the item worn (or carried) by the user of the portable electronic device. As a result, the abuse of portable electronic device can be prevented and information leakage due to leaving or loss can be reduced without damaging usability.

As “the case where it is judged that the portable electronic device receives the signal from the item when an event is generated”, for example, when a pairing item (the registered item paired with the portable electronic device) is a passive wireless tag, the portable electronic device receives an answer signal outputted from the item according to the signal from the portable electronic device. As another example, in the case of active wireless tag, the portable electronic device receives a signal outputted from the pairing item (for example, regularly) one-sidedly. In this case, some kind of signal is not required to be sent from the portable electronic device. Still another example, when FeliCa (registered trademark) system or NFC (Near Field Communication) system is embedded in the portable electronic device, the pairing item detects the result of writing in the memory in FeliCa system or NFC system embedded in the portable electronic device. More specifically, when the CPU of the portable electronic device detects (by the polling (supervision) by CPU or by the notification from FeliCa system or NFC system) the writing of data in the memory in FeliCa system or the memory in NFC system externally without the communication between the portable electronic device and the pairing item, the portable electronic device judges that “the portable electronic device has received the signal from the item when an event is generated”.

The operating range determining unit may ban all operations of the portable electronic device in response to an external access when it is judged that the item can not communicate with the portable electronic device. Also, the operating range determining unit may ban the operation other than the operation according to an urgent message of the portable electronic device in response to an external access when it is judged that the item can not communicate with the portable electronic device.

When it is judged that the item can not communicate with the portable electronic device as described above, it is possible to crack down on the abuse of portable electronic device by banning all operations of the portable electronic device. In banning the operation other than the operation according to an urgent message of the portable electronic device, the abuse of portable electronic device can be noted without damaging usability and the leakage of critical information can be prevented.

The registering unit may register the item information in memory in relation to at least one of a plurality of functions included in the portable electronic device, and the operating range determining unit may allow the operation of the portable electronic device according to a function related to the item information among the plurality of functions included in the portable electronic device when it is judged that the item can communicate with the portable electronic device.

According to this, when it is judged that the item can communicate with the portable electronic device, there is allowed the operation of the portable electronic device according to a function related to the item information among the plurality of functions included in the portable electronic device. Thereby the operation of the portable electronic device can be allowed or the operating range thereof can be limited according to the “presence or absence” or “type/combination” of the item around the portable electronic device by pairing the portable electronic device and the item worn by the owner of the portable electronic device by radio in advance. As a result, the abuse of portable electronic device can be prevented and information leakage due to leaving or loss can be reduced without damaging usability.

The judging unit may judge that the portable electronic device can communicate with the item when the portable electronic device is in the state where it is possible to communicate with the item for a certain period of time or longer. Also, the operating range determining unit may allow the operation of the portable electronic device in response to an external access within a certain period of time after it is judged that the item can communicate with the portable electronic device.

According to this, while not satisfying such a predetermined condition, the operating range of the portable electronic device is limited. For example, by pairing the portable electronic device and the item worn by the owner of the portable electronic device by radio in advance, the operation of the portable electronic device can be allowed or limited “for only a certain period of time after touching” the pairing item around the portable electronic device. Thereby the abuse of portable electronic device can be cracked down on without damaging usability.

The registering unit may provide modes indicating the allowable range of the use of function in phases among the plurality of functions included in the portable electronic device and may register the item information in memory in relation to each of the modes provided in phases, and the operating range determining unit may allow the operation of the portable electronic device according to a function corresponding to the modes related to the item information when it is judged that the item can communicate with the portable electronic device, and may allow the operation of the portable electronic device according to a predetermined minimum function when it is judged that the item specified by the item information can not communicate with the portable electronic device.

According to this, only the operation of the portable electronic device according to a function corresponding to the prefixed modes in the item (i.e., the item that can be communicated) is allowed. In other words, by pairing the portable electronic device and the item worn by the owner of the portable electronic device by radio in advance, the operation of the portable electronic device can be switched according to the “function” allowed by the item. Thereby the operating range of the portable electronic device allowed according to the type of recognized item can be widened or narrowed. As a result, the abuse of portable electronic device can be cracked down on without damaging usability.

The portable electronic device may further include a communicating unit for sending an alert output signal to the item when the operating range determining unit allows the operation of the portable electronic device according to a minimum (alert mode) function.

According to this, an alert can be issued from the portable electronic device to the user owning (carrying) the item. As a result, the information leakage accident due to leaving can be reduced.

In this case, the operating range determining unit may allow the operation of the portable electronic device according to a function corresponding to the modes related to the item information when a signal from the item is received in response to the sent alert output signal.

According to this, when the signal from the item is received, the operation of the portable electronic device is allowed according to the function corresponding to the predetermined mode from a minimum function. Thereby the usability of the user of the portable electronic device is enhanced.

The registering unit may register the item information in memory to specify a plurality of items as a possession other than the portable electronic device, and the operating range determining unit may allow the normal operation of the portable electronic device in response to an external access when the judging unit judges that at least one of the plurality of items can communicate with the portable electronic device and may limit the operating range of the portable electronic device in response to an external access when it is judged that none of the items can communicate with the portable electronic device.

According to this, when the user of the portable electronic device owns a plurality of items, the portable electronic device operates normally in response to an external access with the recognition of at least one of the items. Thereby even when one of the items is left among the plurality of items, the portable electronic device can be used as usual when one of the items is carried. As a result, the abuse of portable electronic device can be prevented while considering usability.

The registering unit may register a priority to send the alert output signal in memory in relation to the plurality of item information registered, and the communicating unit may send the alert output signal to the item specified by the registered item information with higher priority sequentially.

According to this, setting the priority of the item that is more likely to be carried to be high makes it possible to issue an alert in turn from the item that is more likely to be carried. Thereby the user carrying the item can catch the alert early and as a result, information leakage due to leaving can be reduced more.

In addition, the portable electronic device may further include an alerting unit where the portable electronic device itself issues an alert when a signal from the item is not received in response to the sent alert output signal.

According to this, the portable electronic device itself issues an alert. Thereby the user carrying the item can catch the alert early and as a result, the information leakage accident due to leaving can be reduced more.

According to another aspect of the present invention, there is provided a portable electronic device performing radio communication with an item as a possession other than the portable electronic device owned by an owner of the portable electronic device, wherein the portable electronic device, judges, based on the presence or absence of a signal from the item, whether an item specified by the registered item information can communicate with the portable electronic device or not when an event is generated in the portable electronic device, performs a normal operation in response to an external access when it is judged that the item can communicate with the portable electronic device, and performs so as to enhance the security of the portable electronic device by using a function for improving the security provided in the item when it is judged that the item can not communicate with the portable electronic device.

According to this, by performing a pairing registration between the item and the portable electronic device, a function for improving the security provided in the paired item can be used as if the function were a function of the portable electronic device when it is judged that the item can not communicate with the portable electronic device. Thereby even when, for example, a function of security is not provided in the portable electronic device, the security of the portable electronic device can be enhanced by using the function in the item.

In addition, the portable electronic device may send a signal including predetermined critical data registered in the memory of portable electronic device, at a predetermined timing, so as to store the critical data in memory provided in the item.

According to this, even when the portable electronic device becomes distanced from the user, the critical data is copied or rolled out from the portable electronic device to the item and deleted from the portable electronic device. Thereby critical data can be prevented from being leaked or lost due to loss, robbery or accident of the portable electronic device.

According to another aspect of the present invention, there is provided a security system having a portable electronic device connected by radio with an item as a possession other than the portable electronic device owned by an owner of the portable electronic device. In this security system, the portable electronic device includes: a registering unit for registering item information to specify the item in advance in memory, a judging unit for judging, based on the presence or absence of a signal from the item, whether an item specified by the registered item information can communicate with the portable electronic device or not when an event is generated in the portable electronic device, and an operating range determining unit for allowing a normal operation of the portable electronic device in response to an external access when the judging unit judges that the item can communicate with the portable electronic device, and for limiting the operating range of the portable electronic device in response to an external access when it is judged that the item can not communicate with the portable electronic device.

According to this, by performing a pairing registration between the portable electronic device and the item worn (or carried) by the owner of the portable electronic device in advance, the operation of the portable electronic device itself can be allowed or banned, or the use of specific function can be allowed or banned, according to the “presence or absence” of the item around the portable electronic device (pairing item).

According to another aspect of the present invention, there is provided a security system having a portable electronic device connected by radio with an item as a possession other than the portable electronic device owned by an owner of the portable electronic device, wherein, the item includes a function for enhancing a security, and the portable electronic device, judges, based on the presence or absence of a signal from the item, whether an item specified by the registered item information can communicate with the portable electronic device or not when an event is generated in the portable electronic device, performs a normal operation in response to an external access when it is judged that the item can communicate with the portable electronic device, and performs to enhance the security of the portable electronic device by using a function for improving the security provided in the item when it is judged that the item can not communicate with the portable electronic device.

According to this, by performing a pairing registration between the item and the portable electronic device, a function for improving the security provided in the paired item can be used as if the function were a function of the portable electronic device when it is judged that the item can not communicate with the portable electronic device. Thereby the security of the portable electronic device can be enhanced by using the function in the item.

The portable electronic device, by sending an alert output signal to the item, may use an alerting function as a function for improving the security provided in the item to generate an alert in the item according to the sent alert output signal, when it is judged that the item specified by the item information can not communicate with the portable electronic device.

According to this, by pairing the portable electronic device and the item worn by the owner of the portable electronic device by radio in advance to use the alerting function of the item by the signal from the portable electronic device, the user carrying the item can learn the alert early.

In addition, the portable electronic device, by sending a signal including predetermined critical data at a predetermined timing, may store the critical data included in the sent signal in memory provided in the item using a storing function as a function for improving the security.

According to this, the critical data is copied or rolled out from the portable electronic device to the item and deleted from the portable electronic device with the use of storing function of the item. Thereby, by pairing the portable electronic device and the item worn by the owner of the portable electronic device by radio in advance, memory function of the item can be used from the portable electronic device. Thereby critical data can be prevented from being leaked or lost due to loss, robbery or failure of the portable electronic device.

According to another aspect of the present invention, there is provided an allowable operating range determining method of portable electronic device performing radio communication with an item as a possession other than the portable electronic device owned by an owner of the portable electronic device, and the allowable operating range determining method includes registering item information to specify the item in advance in memory, judging, based on the presence or absence of a signal from the item, whether an item specified by the registered item information can communicate with the portable electronic device or not when an event is generated in the portable electronic device, and allowing a normal operation of the portable electronic device in response to an external access when it is judged that the item can communicate with the portable electronic device, and limiting the operating range of the portable electronic device in response to an external access when it is judged that the item can not communicate with the portable electronic device.

According to this, by performing a pairing registration between the portable electronic device and the item worn by the owner of the portable electronic device in advance, the operation of the portable electronic device itself can be allowed or banned, or the use of specific function can be allowed or banned, according to the “presence or absence” of the item around the portable electronic device.

According to the present invention as described above, there can be provided a portable electronic device limiting an allowable operating range thereof to enhance a security, a security system using the portable electronic device and an allowable operating range determining method of portable electronic device.

### BRIEF DESCRIPTION OF THE DRAWINGS

FIG. 1 is a whole configuration diagram according to a first embodiment of the present invention.

FIG. 2 is an internal configuration diagram of each device according to the first-fourth embodiments.

FIG. 3 is a functional block diagram showing functions of each device according to the first-fourth embodiments.

FIG. 4 is a diagram showing pairing item information to allow a use of mobile-phone itself in the first embodiment.

FIG. 5 is a diagram showing pairing item information to allow a use of specific function of mobile-phone in the first embodiment.

FIG. 6 is a whole configuration diagram according to a second embodiment of the present invention.

FIG. 7 is a diagram indicating correlations between a security mode and the mobile-phone in the second-fourth embodiments.

FIG. 8 is a diagram indicating a correlation between the security mode and a pairing item in the second embodiment.

FIG. 9 is a diagram indicating a correlation between each scene and the change of security mode in the second embodiment.

FIG. 10 is a whole configuration diagram according to a third embodiment of the present invention.

FIG. 11 is a diagram indicating a correlation between the security mode and the pairing item in the third embodiment.

FIG. 12 is a whole configuration diagram according to a fourth embodiment of the present invention.

FIG. 13 is a diagram indicating a correlation between the security mode and the pairing item in the fourth embodiment.

### DESCRIPTION OF THE NUMERALS

10 security system
100 mobile-phone
101 item (watch)
102 item (employee ID card)
501 registering unit
502,602,605 communicating unit
503 judging unit
504 operating range determining unit
505,603,606 alerting unit
601,604 storing unit

### DETAILED DESCRIPTION OF THE EMBODIMENTS

Hereinafter, the preferred embodiments of the present invention will be described in reference to the accompanying drawings. Same reference numerals are attached to components having same functions in following description and the accompanying drawings, and a description thereof is omitted.

### First Embodiment

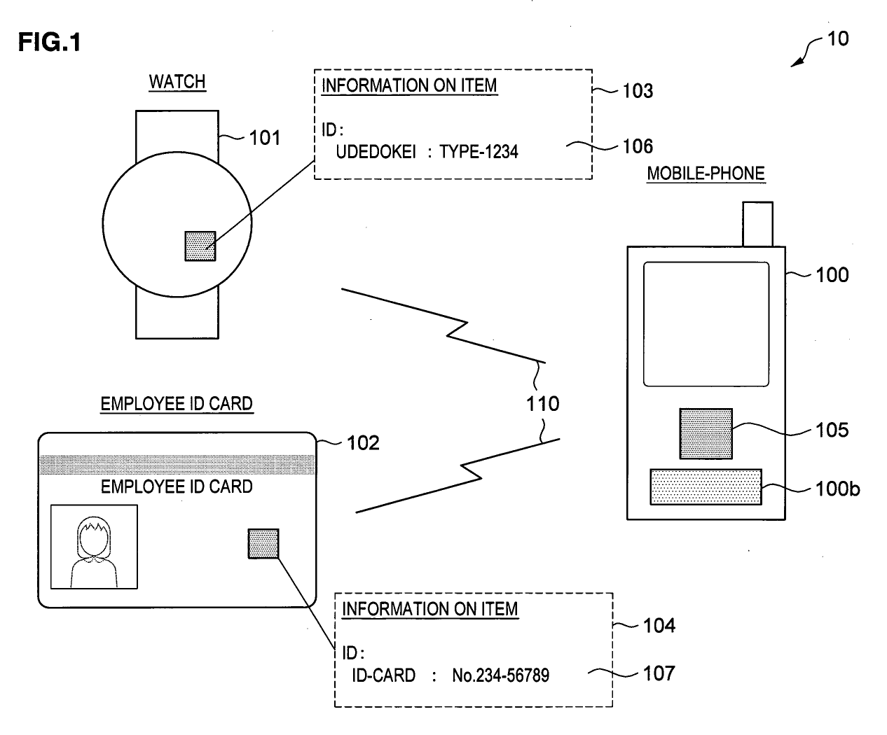

First, a whole configuration of a security system according to the first embodiment of the present invention will be described in reference to FIG. 1. A security system 10 according to this embodiment is configured by a mobile-phone 100 as an example of mobile terminal and items 101, 102. The mobile-phone 100 is connected to the items 101, 102 by a radio interface 110.

<1-1> Mobile-Phone

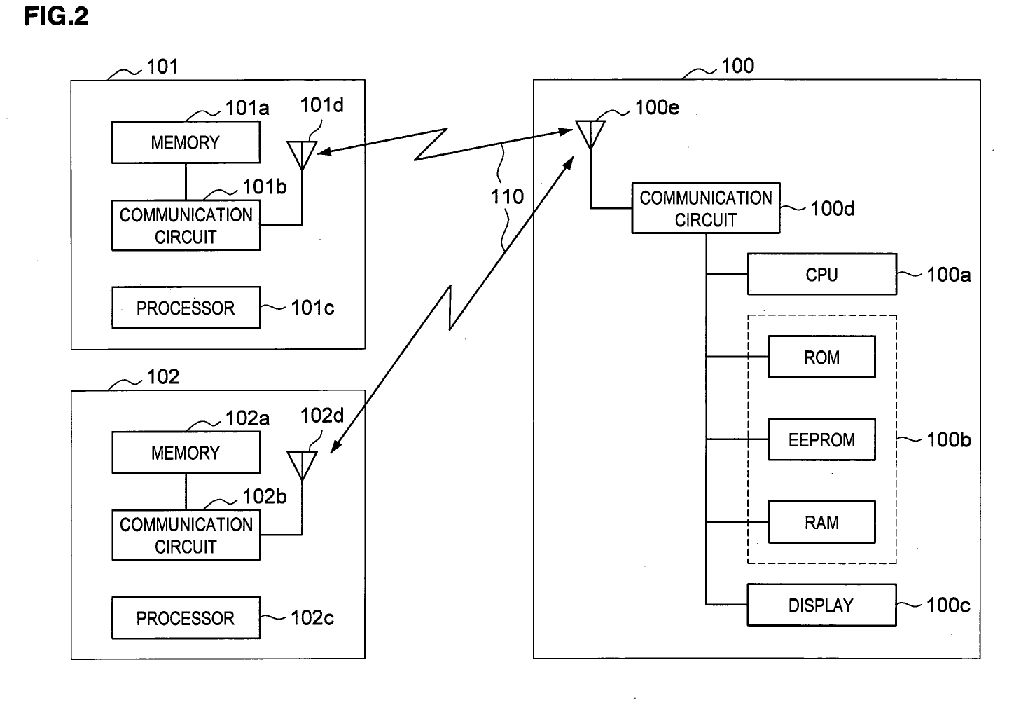

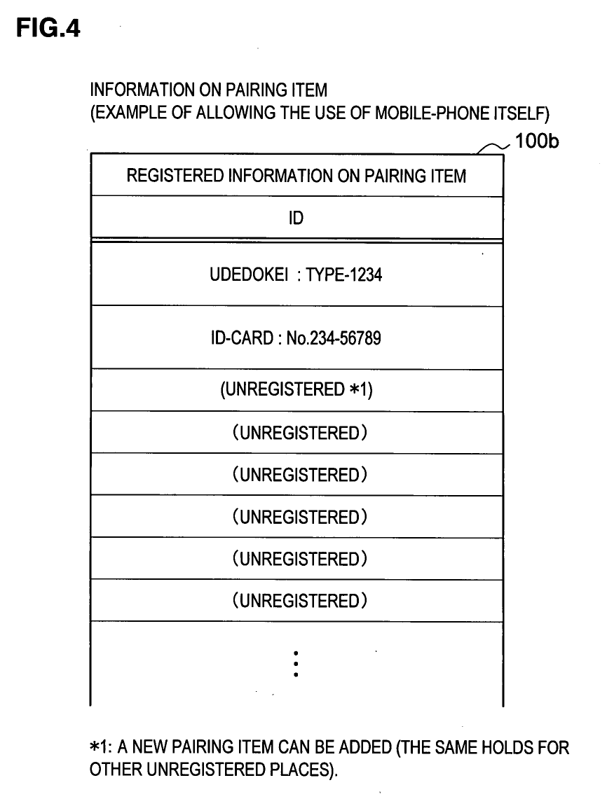

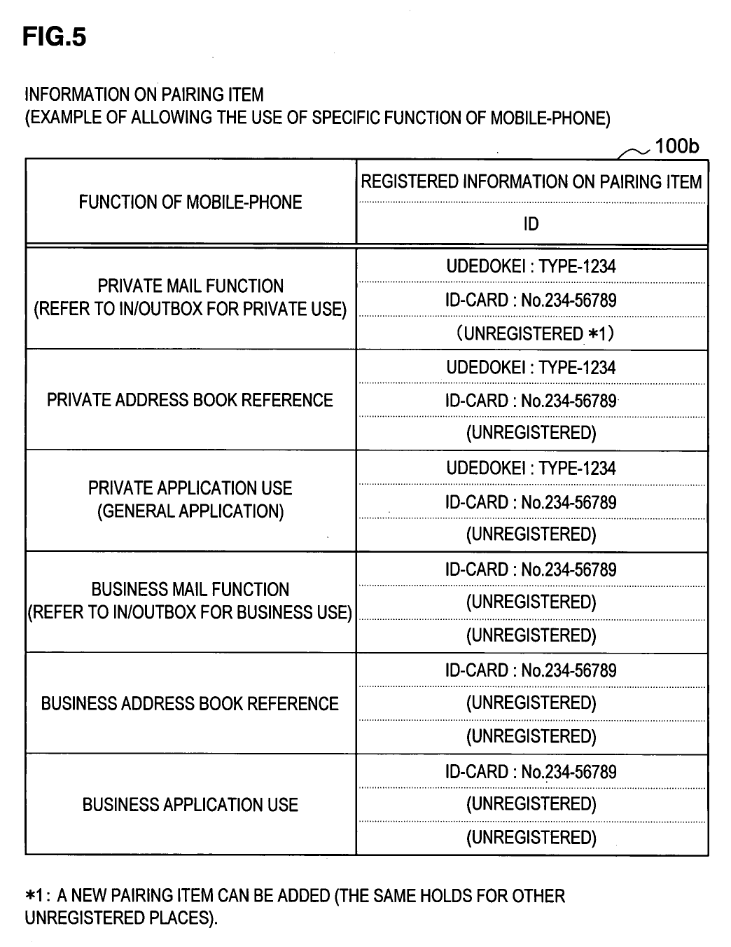

As shown in FIG. 2, the mobile-phone 100 is configured by a CPU 100a, memory 100b, a display 100c, a communication circuit 100d (including a communication function 105 for acquiring information 103, 104 on items to be described later that is stored in the items 101, 102 for pairing); and an antenna 100e. The memory 100b includes ROM, RAM and EEPROM, and in EEPROM, for example, pairing item information shown in FIGS. 4 and 5 is registered. In ROM, for example, a program for performing this system is stored. The CPU 100a achieves the function of this system by performing the program stored in the ROM while using the pairing item information registered in the EEPROM.

<1-2> Pairing Item

In this embodiment, pairing item will be exemplified by a watch 101 and an employee ID card 102 in FIG. 1. Here, the pairing item is what is owned by an owner of the mobile-phone 100, worn when going outside and carried in the owner's pocket or bag. The pairing item is no limited to the watch 101 and the employee ID card 102, as other examples, an accessory such as ring and necklace, an audio player (silicon-audio, HDD-audio, etc.), a headphone (with/without remote control), a hands-free headset of mobile-phone, a dress-up cover (cover) of mobile-phone and so on can be given.

As shown in FIG. 2, the pairing item 101 is configured by memory 101a, a communication circuit 101b, a processor 101c, and an antenna 101d. Information 103 on the pairing item in FIG. 1 (item information) is stored in the memory 101a. Similarly, the pairing item 102 is configured by memory 102a, a communication circuit 102b, a processor 102c, and an antenna 102d. Information 104 on the pairing item is stored in the memory 102a.

The information 103, 104 on the pairing item is radio communicated via the antenna 101d, the antenna 102d and the antenna 100e (for example, wireless tag, Bluetooth, etc.) and is provided to the mobile-phone 100. Here, the information 103, 104 on the item may include IDs 106, 107 specific to the item, an item name, a product code (for example, JAN-code) and so on.

As a method of acquiring the information 103, 104 on the item from the items 101, 102 by using the radio interface 110 on the mobile-phone 100's side, using a wireless tag, ZigBee, Bluetooth, a wireless LAN and so on can be assumed. In the case of using a wireless tag, the mobile-phone 100 may be to have a wireless tag, a wireless tag reader and so on installed. The wireless tag standard includes NFC (Near Field Communication), FeliCa (registered trademark) and so on.

Note that in this embodiment, the type of radio communication (communication standard, form, power supply method, etc.) is not specified. In installing in the item (pairing items 101, 102) used by combing a plurality thereof (i.e., being paired), the most suitable type is selected and it is assumed that a communication means 105 (for example, wireless tag reader, Bluetooth (registered trademark) communication function) capable of using the type (one or more types) is installed in the mobile-phone 100.

<1-3> Functions of Mobile-Phone and Pairing Item

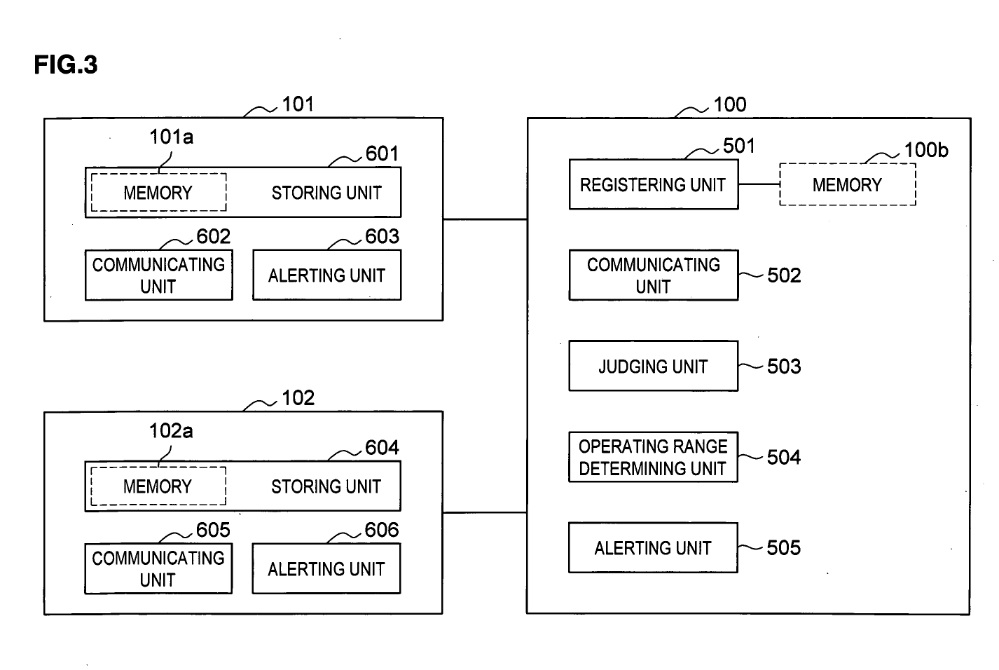

Next, there will be described the functions of the mobile-phone 100 and the pairing items 101, 102 in reference to FIG. 3 indicating a functional block diagram showing functions of the mobile-phone 100 and the items 101, 102.

First, the function of the mobile-phone 100 will be described. The mobile-phone 100 includes each function indicated by a registering unit 501, a communicating unit 502, a judging unit 503, an operating range determining unit 504 and an alerting unit 505. The registering unit 501 registers item information 103, 104 to specify the items 101, 102 in the memory 100b in advance. The communicating unit 502 (communicating unit on the electronic device's side) receives the signals from the items 101, 102 so as to recognize the items 101, 102 when an event is generated in the mobile-phone 100.

The judging unit 503 judges, based on the presence or absence of the signals from the items 101, 102, whether the item (item 101 or item 102) specified by the item information registered in the memory 100b can communicate with the mobile-phone 100 or not, in other words, whether the items 101, 102 can be recognized or not.

The operating range determining unit 504 allows a normal operation of the mobile-phone 100 in response to an external access (user of the mobile-phone) when the judging unit 503 judges that either the item 101 or 102 can communicate with the mobile-phone 100, and limits the operating range of the mobile-phone 100 in response to an external access when the judging unit 503 does not judge that the items 101, 102 can communicate with the mobile-phone 100. Here, “limiting the operating range of the mobile-phone 100” means, for example, banning all operations, banning the operation according to the functions other than a part of functions of the mobile-phone 100 or switching the range of allowable operation in phases.

The alerting unit 505 (alerting unit on the electronic device's side) issues an alert when the answer signal is not received from the items 101, 102 in response to an alert output signal issued when the items 101, 102 cannot be recognized.

Next, the function of the item 101 will be described. The item 101 includes each function indicated by a storing unit 601 for storing data in the memory 101a, a communicating unit 602 and an alerting unit 603. The storing unit 601 stores the critical data included in the signal sent from the mobile-phone 100 in the memory 101a. The communicating unit 602 (communicating unit on the item's side) communicates with the mobile-phone 100 by radio. The alerting unit 603 (alerting unit on the item's side) issues an alert in response to the alert output signal sent from the mobile-phone 100. In addition, the item 102 includes each function indicated by a storing unit 604 for storing data in the memory 102a, a communicating unit 605 and an alerting unit 606. With regard to the function of the item 102, which is the same as the function of the item 101, the description thereof will be omitted. It may be noted that the alerting unit 603 of the item 101 and the alerting unit 606 of the item 102 do not have to be necessarily installed in the items 101 and 102.

<1-4> Pairing

Next, the pairing method between the mobile-phone 100 and the items 101, 102 will be described. The method itself for placing the mobile-phone 100 in a pairing mode is not regulated here. In the first embodiment, only when the mobile-phone 100 recognizes the pairing item, the pairing is performed so as to allow the use of the mobile-phone 100 itself or the use of the specific function of the mobile-phone 100.

In pairing, the owner of this system prepares the mobile-phone 100 and the pairing items 101, 102. After placed the mobile-phone 100 in the pairing mode with the menu operation of the mobile-phone 100, the wireless tag part or the wireless tag reader part of the mobile-phone 100 is touched with the pairing items 101, 102.

In accordance to this, the CPU 100a (registering unit 501) of the mobile-phone 100 sets the pairing. In the case of the items whose communication is performed by Bluetooth, etc., the CPU 100a searches the pairing item to select not by touching with the pairing item but by bringing closer to the mobile-phone 100.

In addition, the CPU 100a (registering unit 501) adds or deletes the pairing item as required. The item to be paired with the mobile-phone 100 does not necessarily have to be one for one mobile-phone. The CPU 100a (registering unit 501) may register a plurality of item information corresponding to a plurality of items as the pairing item.

As this, the memory 100b of the mobile-phone 100 holds information 103, 104 on the registered pairing items. FIG. 4 shows an example of pairing item information stored in the memory 100b in case of allowing the use of the mobile-phone 100 itself. In addition, FIG. 5 shows an example of pairing item information held by the memory 100b in allowing the use of specific function of the mobile-phone 100.

<1-5> Normal Using

After the completion of the pairing and setting of security mode, the mobile-phone 100 is placed in the normal use. In this state, the CPU 100a (judging unit 503) of the mobile-phone 100 tries to recognize, by using the radio communication means 105 (for example, wireless tag reader or Bluetooth communication) with the communication circuit 100d and the antenna 100e installed in the mobile-phone 100, whether the pairing items 101, 102 exist (whether the peripheral pairing items can be recognized, there is touched for a certain period of time or there has been touched within a certain period of time) when an event is generated (regularly, or at the times of application use/address book data reference/opening flip phone and so on).

<1-6> The Case where the Paired Item can be Recognized

In the next, there will be described an actual usage scene when the paired item can be recognized. In the first embodiment, when the CPU 100a (judging unit 503) of the mobile-phone 100 recognizes either pairing item 101 or 102 registered in the memory 100b in FIG. 4, the CPU 100a (operating range determining unit 504) unlocks the operation of the mobile-phone 100 to allow the use of the mobile-phone 100 itself. When nothing is recognized, the CPU 100a (operating range determining unit 504) locks the mobile-phone 100 to ban the use of the mobile-phone 100 itself.

Or, when the CPU 100a allows the use of specific function of the mobile-phone 100, the CPU 100a (operating range determining unit 504) allows the use of the function of the mobile-phone 100 corresponding to the place where the pairing items 101, 102 are registered in the memory 100b in FIG. 5. In FIG. 5, the following example is shown. When the watch (item 101) is recognized, only the use of function related to private use is allowed. When the employee ID card (item 102) is recognized, the use of all functions is allowed.

For example, since the pairing item 101 (UDEDOKEI, TYPE-1234) is registered in a private mail function, the CPU 100a (operating range determining unit 504) recognizes either the pairing item 101 or 102 (concretely, recognizes the pairing item 101) to allow the use of the private mail function of the mobile-phone 100.

As an example of the case where the CPU 100a (judging unit 503) “judges that the item is recognized”, when a pairing item (item registered paired with the portable electronic device) is a passive type of wireless tag, an answer signal may be received from the item according to the signal outputting from the portable electronic device. As another example, in the case of active type of wireless tag, the signal from the pairing item (for example, regularly) may be received one-sidedly. In this case, some kind of signal is not required to be sent from the portable electronic device. Still another example, when FeliCa (registered trademark) system or NFC (Near Field Communication) system is embedded in the portable electronic device, the pairing item detects the result of writing in the memory in FeliCa system or the memory in NFC system embedded in the portable electronic device. More specifically, when the CPU of the portable electronic device detects (by the polling (supervision) by CPU or by the notification from FeliCa system or NFC system) the writing of data in the memory in FeliCa system or the memory in NFC system externally without the communication between the portable electronic device and the pairing item, the portable electronic device judges that “the portable electronic device has received the signal from the item when an event is generated”.

<1-7> The Case where the Paired Item Cannot be Recognized

In the next, there will be described an actual usage scene when the paired item cannot be recognized. When the CPU 100a (judging unit 503) of the mobile-phone 100 can recognize neither item 101 nor 102 registered in the memory 100b of the mobile-phone 100, the CPU 100a (operating range determining unit 504) locks the operation of the mobile-phone 100.

“None of the pairing items can be recognized” means that the mobile-phone 100 recognizes that the owner is not near the mobile-phone 100. When the mobile-phone 100 is left or stolen, there is placed in this state. In the first embodiment, when none of the pairing items can be recognized, the operation of the mobile-phone 100 is locked and no function can be used. However, the CPU 100a (operating range determining unit 504) may be used only for issuing an urgent message.

According to the first embodiment, as described above, the operation of the mobile-phone 100 can be allowed or prohibited according to the “presence or absence” of the item worn (or carried) by the user of the mobile-phone 100. As a result, the abuse of mobile-phone 100 can be prevented and information leakage due to leaving or loss can be reduced without decreasing usability.

### Second Embodiment

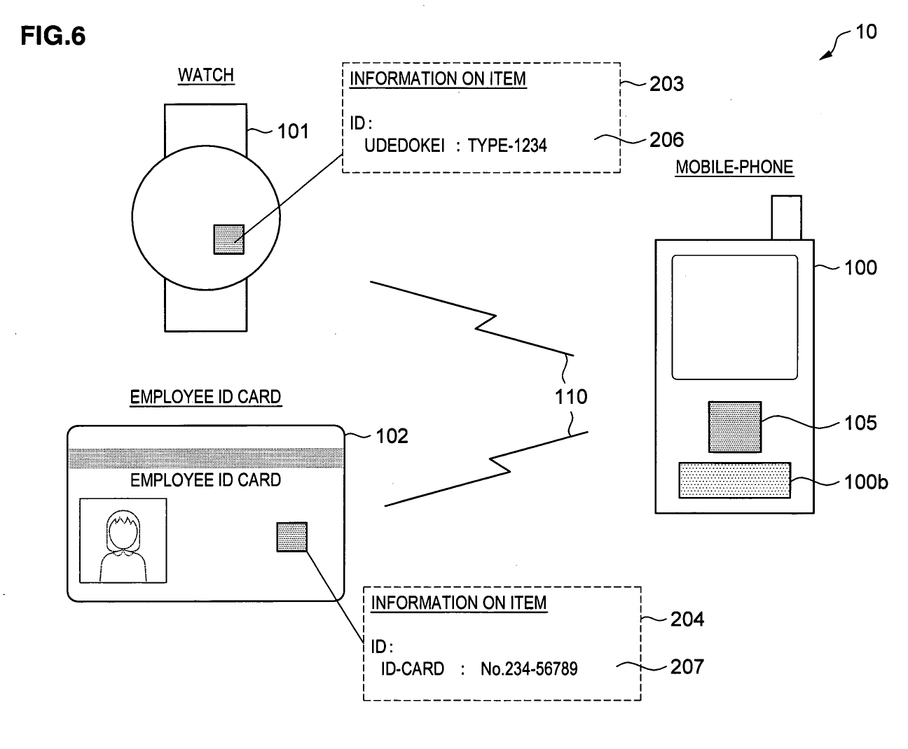

Next, the second embodiment will be described in reference to FIG. 6. The second embodiment is different from the first embodiment in the following point. When the mobile-phone 100 recognizes the pairing item, the specific function of the mobile-phone 100 can be grouped and set in several modes in advance as “private mode/business mode/alert mode” instead of correlating the pairing item for numerous specific functions of the mobile-phone 100. In this embodiment, in other words, the pairing item is correlated according to several modes and the use of specific function of the mobile-phone 100 is allowed or banned corresponding to each of the several modes. Consequently, there will be described a security system 10 according to the second embodiment will be described sequentially centering this difference.

The whole configuration in this embodiment shown in FIG. 6 is the same as in the first embodiment. In this embodiment, however, information 203, 204 on the item stored in the pairing items 101, 102 for pairing is set grouped according to several modes.

<2-1> Mobile-Phone

In FIG. 6, the mobile-phone 100 in the second embodiment is configured by a communication function 105 for acquiring information 203, 204 on item stored in the items 101, 102 for pairing and a function of registering and holding the acquired information 203, 204 on the item (memory 100b). The information 203, 204 on the item indicate IDs 206, 207 specific to the item, an item name, a product code (for example, JAN-code) and so on.

<2-2> Pairing Item

In this embodiment, pairing item will be exemplified by a watch 101 and an employee ID card 102 similarly to the first embodiment. As described above, the pairing item is what is owned by an owner of the mobile-phone 100, worn when going outside and carried in the owner's pocket or bag, and is not limited to the watch 101 and the employee ID card 102. As other examples, an accessory such as ring and necklace, an audio player (silicon-audio, HDD-audio, etc.), a headphone (with/without remote control), a hands-free headset of mobile-phone, a dress-up cover (cover) of mobile-phone and so on can be given.

In these pairing items 101, 102, the information 203, 204 on the pairing item that can be acquired by the mobile-phone 100 by using radio communication (for example, wireless tag, Bluetooth, etc.) is stored. The contents of information can include the IDs 206, 207 of the item.

As a method of acquiring the information 203, 204 on the item, as described above, using a wireless tag, ZigBee, Bluetooth, a wireless LAN and so on can be assumed. In the case of using a wireless tag, the mobile-phone 100 has a wireless tag, a wireless tag reader and so on. The wireless tag standard includes NFC, FeliCa and so on.

In this embodiment, the type of radio communication (communication standard, form, power supply method, etc.) is not specified. In installing in the pairing items 101, 102 used by combing, the most suitable type is selected and it is assumed that a communication means 105 (for example, wireless tag reader, Bluetooth communication function) capable of using the radio communication (one or more) is installed in the mobile-phone 100.

<2-3> Pairing

Next, the pairing method in this embodiment will be described. The method itself for placing the mobile-phone 100 in a pairing mode is not regulated here. In the second embodiment, only when the mobile-phone 100 recognizes the pairing item, the pairing is performed so as to allow the use of the specific function of the mobile-phone 100.

In pairing, the owner of this system prepares the mobile-phone 100 and the pairing items 101, 102 described in <2-2>. After placed the mobile-phone 100 in the pairing mode with the menu operation of the mobile-phone 100, the wireless tag part or the wireless tag reader part of the mobile-phone 100 is touched with the pairing items 101, 102. Thereby the CPU 100a of the mobile-phone 100 acquires the information 203, 204 on the pairing item to hold in the mobile-phone 100.

In the case of the items whose communication is performed by Bluetooth, etc., the CPU 100a of the mobile-phone 100 searches the pairing item to select not by touching with the pairing item but by bringing closer to the mobile-phone 100. In addition, the pairing item is added or deleted as required. The item to be paired with the mobile-phone 100 does not necessarily have to be one for one mobile-phone. A plurality of items can be registered as the pairing item and held in the mobile-phone 100.

<2-4> Security Mode Setting

In the second embodiment, the CPU 100a (registering unit 501) of the mobile-phone 100 operates switched to three modes, “private mode/business mode/alert mode” according to the type and combination of the pairing items 101, 102 recognized in normal using. For example, when none of the pairing items 101, 102 can be recognized, the CPU 100a (registering unit 501) of the mobile-phone 100 sets the mobile-phone 100 at “alert mode”. Even when the items cannot be recognized in the predetermined number, however, the CPU 100a may set the mobile-phone 100 at “alert mode”. Even when the items cannot be recognized in the predetermined type, the CPU 100a may set the mobile-phone 100 at “alert mode”.

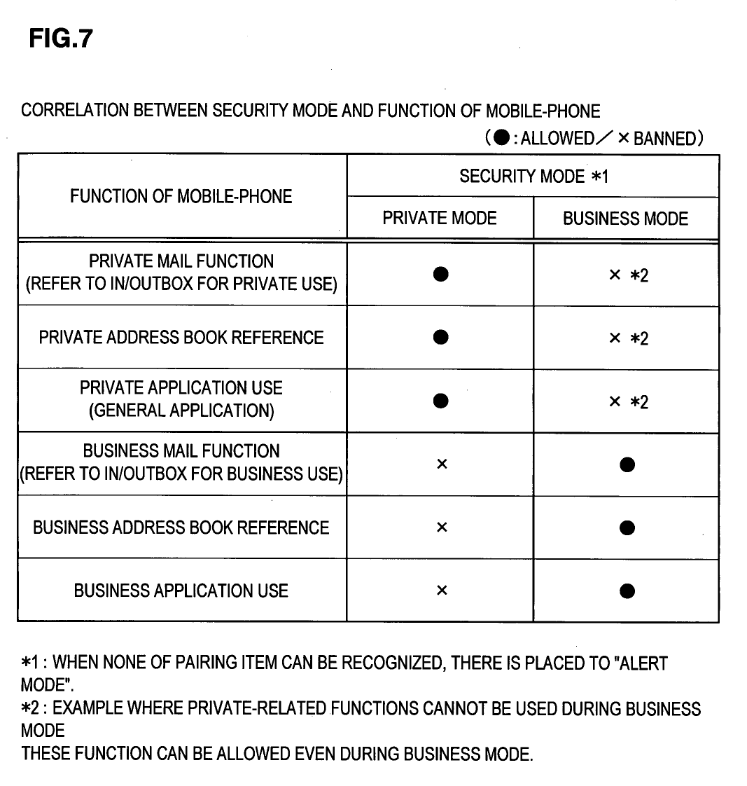

As in FIG. 7 showing the function of the mobile-phone 100 correlated with each security mode, the CPU 100a (registering unit 501) of the mobile-phone 100 sets which function is allowed/banned to be used in the mobile-phone 100, first for each mode of “private mode” and “business mode” in the setting of security mode, and the memory 100b of the mobile-phone 100 holds the set contents. In other words, the CPU 100a (registering unit 501) provides modes indicating the range of the use of function in phases among the plurality of functions included in the mobile-phone 100 and registers the item information in the memory 100b in relation to each of the modes provided in phases.

In FIG. 7, when none of the pairing items can be recognized, there is set at “alert mode”. Here, “alert mode” is the mode to allow the use of minimum function of the mobile-phone 100 (degree of allowable operating range of the mobile-phone 100). In addition, each mode is set under the condition where the functions related to the private mode cannot be used during the business mode. However, these functions can be allowed during the business mode.

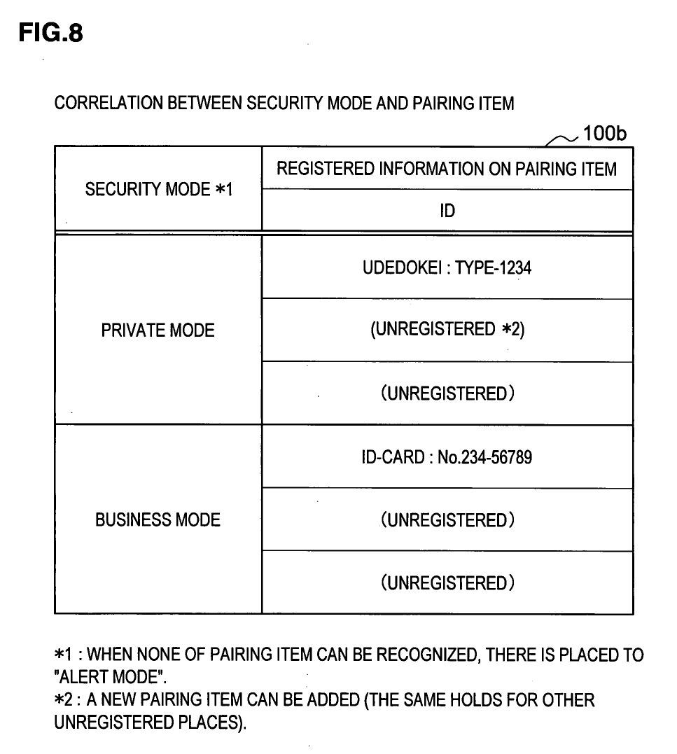

As in FIG. 8 showing an example of pairing item correlated with each security mode, the memory 100b in the CPU 100a sets which pairing items 101, 102 is correlated with each mode of “private mode” and “business mode”, and the memory 100b of the mobile-phone 100 holds the information set in the mobile-phone 100.

<2-5> Normal Using

After the completion of the pairing and setting of security mode by the CPU 100a (registering unit 501) of the mobile-phone 100, the mobile-phone 100 is placed in the normal use. In this state, the CPU 100a (communicating unit 502, judging unit 503) of the mobile-phone 100 tries to recognize, by using the radio communication means 105 (for example, wireless tag reader or Bluetooth communication) installed in the mobile-phone 100, whether the pairing items 101, 102 exist (whether the peripheral pairing items can be recognized, there is touched for a certain period of time or there has been touched within a certain period of time) when an event is generated (regularly, or at the times of application use/address book data reference/opening flip phone).

According to how many items can be recognized among the types of the items 101, 102 paired in advance, or which item can be recognized, the CPU 100a (operating range determining unit 504) of the mobile-phone 100 switches the mode of the mobile-phone 100 to one of the security modes set in FIG. 8. Thereby the function of the mobile-phone 100 is allowed to be used within the set range.

<2-6> The Case where the Paired Item can be Recognized

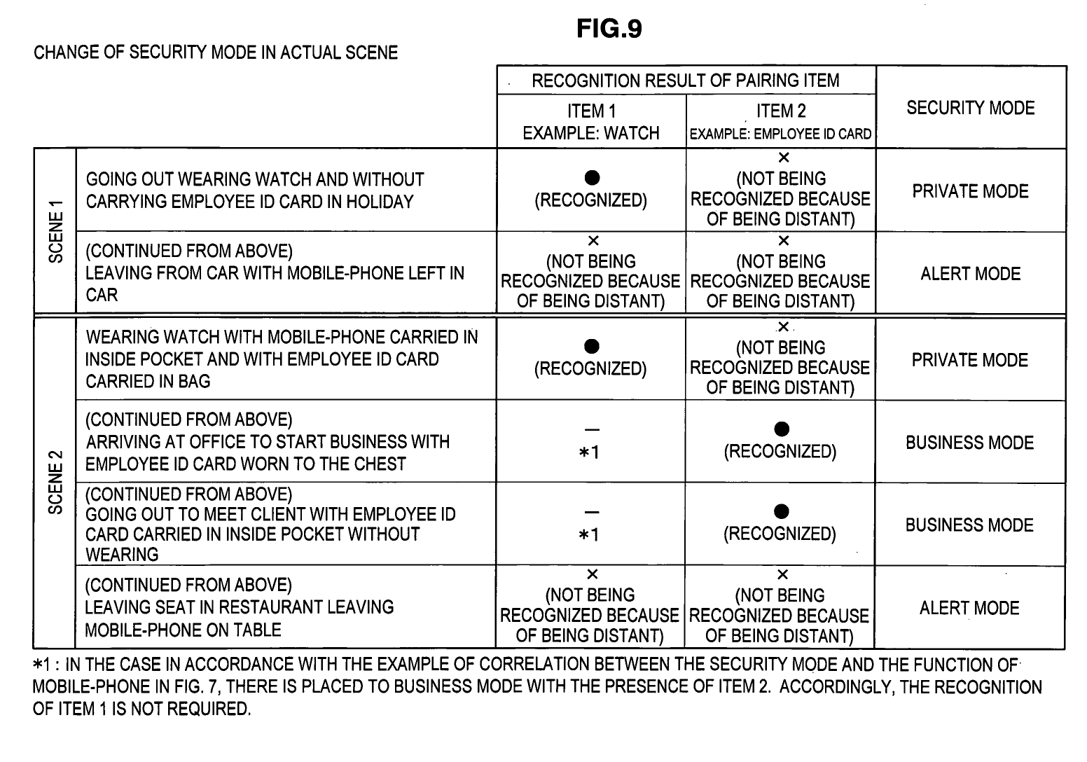

In the next, there will be described an actual usage scene when the paired item can be recognized. When the CPU 100a (judging unit 503) of the mobile-phone 100 can recognize the pairing items 101 and 102, the CPU 100a (operating range determining unit 504) of the mobile-phone 100 switches the mode of the mobile-phone 100 to the security modes set in FIG. 8. Thereby the function is allowed to be used within the setting range indicated in FIG. 7 among the functions of the mobile-phone 100. FIG. 9 shows an example of the change of security mode in an actual scene.

For example, in the case of going out wearing a watch and without carrying an employee ID card in a holiday (scene 1 in FIG. 9), although an item 1 (watch) is recognized by the CPU 100a of the mobile-phone 100 an item 2 (employee ID card) is not recognized. The security mode of the mobile-phone 100, at this time, is set at the private mode. In addition, for example, in the case of going out to meet a client with the employee ID card carried in an inside pocket without wearing (scene 2 in FIG. 9), since the item 2 (employee ID card) is recognized the item 1 (watch) does not have to be recognized. The security mode of the mobile-phone 100, at this time, is set at the business mode. Further, in the case of leaving the seat in restaurant leaving the mobile-phone 100 on the table, neither the item 1 nor 2 is recognized. The security mode of the mobile-phone 100, at this time, is set at the alert mode.

In these examples, there has been described the state where the mobile-phone 100 recognizes the pairing items 101, 102 only by carrying the pairing items 101, 102 near the mobile-phone 100 on the owner's side. However, this system is not limited to these examples and can use a way of making the recognition by apparently touching the pairing items 101, 102 to the mobile-phone 100 at the start of using a business application. There is not a substantial difference between carrying and touching with regard to acquisition of information by a wireless tag and only a difference in radio field intensity. There can be realized by adjusting allowable usable distance.

<2-7> The Case where the Paired Item Cannot be Recognized

In the next, there will be described an actual usage scene when the paired item cannot be recognized. When the CPU 100a (judging unit 503) of the mobile-phone 100 can recognize neither item 101 nor 102 in the case where the correlation between the mobile-phone 100 and the security mode is set as in FIG. 7, the CPU 100a (operating range determining unit 504) of the mobile-phone 100 switches the mobile-phone 100 to “alert mode”. Thereby neither the private function nor the business function of the mobile-phone 100 can be used. “None of the pairing items can be recognized” means the owner is not near the mobile-phone 100. When the mobile-phone 100 is left or stolen, there is placed in this state.

According to the second embodiment, as described above, the operation of the mobile-phone 100 (i.e., the usable range of the function of the mobile-phone 100) can be switched or limited according to the “presence or absence” or “type/combination” of the item worn (or carried) by the user of the mobile-phone 100. As a result, there can be obtained the advantage where the abuse of mobile-phone 100 can be prevented and information leakage due to leaving or loss can be reduced without damaging usability.

### Third Embodiment

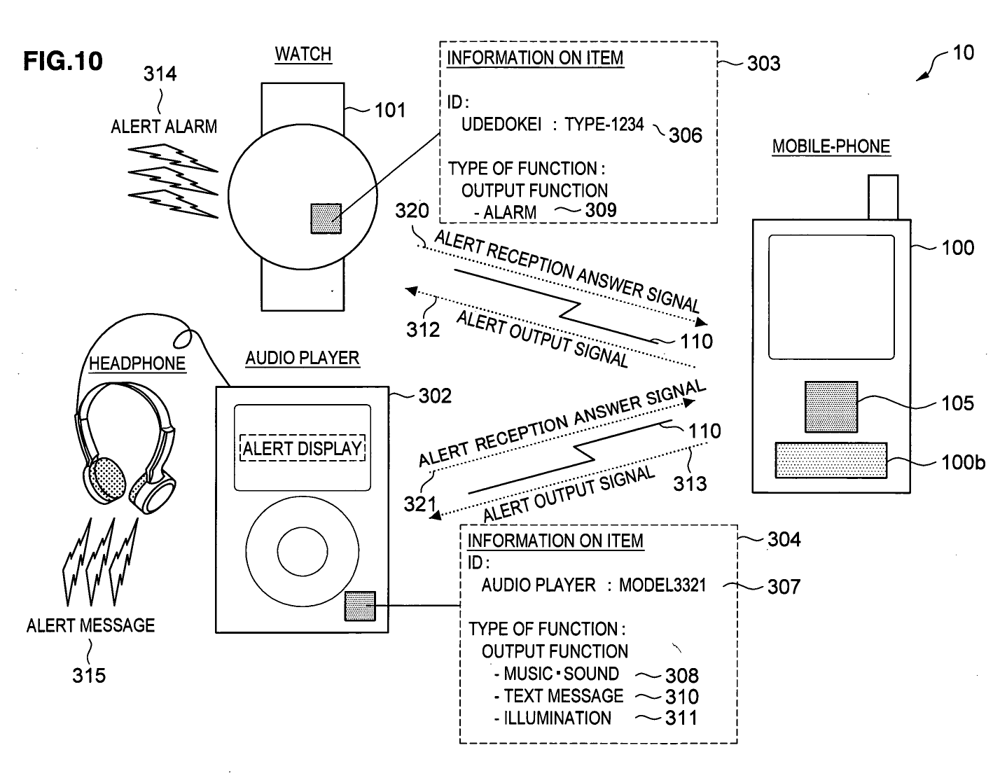

Next, the third embodiment will be described in reference to FIG. 10. The third embodiment is different from the second embodiment in the following point. When none of the pairing items can be recognized, the mobile-phone 100 can control the pairing item to issue an alert. There are various types and shapes of the object as the candidate of the pairing item, which can, for example, sound or blink a light. In this system, the mobile-phone 100 can discriminate the function of each item to set the alerting method suitable for the pairing item and to select automatically the method of outputting the alert suitable for the pairing item. Consequently, there will be described a security system 10 according to the third embodiment will be described sequentially centering this difference.

<3-1> Mobile Terminal

In FIG. 10, the mobile-phone 100 is exemplified as the mobile terminal. In the second embodiment, the mobile-phone 100 only acquires the information inside the pairing item unidirectionally. In the third embodiment, however, the command of alert or output of alert (hereafter, referred to as alert output signals 312, 313) is sent by radio from the mobile-phone 100 to the pairing items 101, 302 to output an alert (alert alarm 314, alert message 315) from the pairing items 101, 302 to the owner.

<3-2> Pairing Item

In FIG. 10, pairing item will be exemplified by a watch and an audio player. In each memory of these pairing items 101, 302, the information 303, 304 on item that can be acquired by the mobile-phone 100 by the radio communication means 105 (for example, wireless tag reader or Bluetooth communication) are stored.

In the third embodiment, in the information 303, 304 on item the type of usable function (information 308-311 on output function) is stored as well as the same IDs 306, 307 as those stored in the second embodiment. The information 308-311 on output function indicate what kind of output function the item itself includes, and, for example, sound/music allowable 308, buzzer sound allowable 309, text display allowable 310, illumination allowable 311 and vibration allowable can be exemplified. In addition, each item may include a plurality of functions.

At the time of alert output, the pairing items 101, 302 have the function of outputting an alert (alert alarm 314, alert message 315) to the owner of the item by receiving the alert output signals 312, 313 from the mobile-phone 100. In the case of the item 101 (watch), for example, upon receiving the alert output signal 312, the item 101 outputs an alert (alert alarm 314) by alarm. In the case of the item 302 (audio player), the item 302 outputs a voice message or beep tones from the mobile-phone 100 through a headphone (alert message 315). Thereby the mobile-phone 100 issues an alert to the owner. In addition, however, although the output of “alert” is assumed, other normal message may be output such as notifying of calling.

<3-3> Pairing

Next, the pairing method in this embodiment will be described. The method for placing the mobile-phone 100 itself in a pairing mode is not regulated here, similarly to the second embodiment. In the third embodiment, as in the second embodiment, only when the mobile-phone 100 recognizes the pairing item, the pairing is performed so as to allow the use of the specific function of the mobile-phone 100.

In pairing, the mobile-phone 100 and the pairing items 101, 302 described in <3-2> is prepared. Then with the menu manipulation of the mobile-phone 100 there is placed in the pairing mode, and the pairing setting is achieved by having the wireless tag part or the wireless tag reader part of the mobile-phone 100 touched with the pairing items 101, 102. Note that in the case of the items whose communication is performed by Bluetooth, etc., the mobile-phone 100 searches the pairing item to select not by touching with the pairing item but by bringing closer to the mobile-phone 100.

In addition, the pairing item is added or deleted as required. The item to be paired with the mobile-phone 100 does not necessarily have to be one for one mobile-phone. A plurality of items can be registered as the pairing item and held in the mobile-phone 100.

The mobile-phone 100 acquires the information 303, 304 on the pairing item to discriminate the supported information 308-311 on output function and to set the output method of the alert output signal suitable for the pairing item for alerting. In addition, the information is stored in the memory 100b in the mobile-phone 100.

<3-4> Security Mode Setting

The setting of security mode in this embodiment is the same as in the second embodiment. The mobile-phone 100 is switched to three modes, “private mode/business mode/alert mode” according to the type and combination of the pairing items 101, 302 recognized in normal using and acts. For example, as described above, when none of the pairing items 101, 102 can be recognized, the CPU 100a (registering unit 501) of the mobile-phone 100 may set the mobile-phone 100 at “alert mode”. Or, when the items cannot be recognized in the predetermined number or type, the CPU 100a may set the mobile-phone 100 at “alert mode”.

First, the CPU 100a (registering unit 501) of the mobile-phone 100 sets each of the security modes (“private mode” and “business mode”) indicating which function is allowed/banned to be used in the mobile-phone 100 to hold in the memory 100b in the mobile-phone 100. FIG. 7 described above shows the example of the mobile-phone 100 correlated with each security mode.

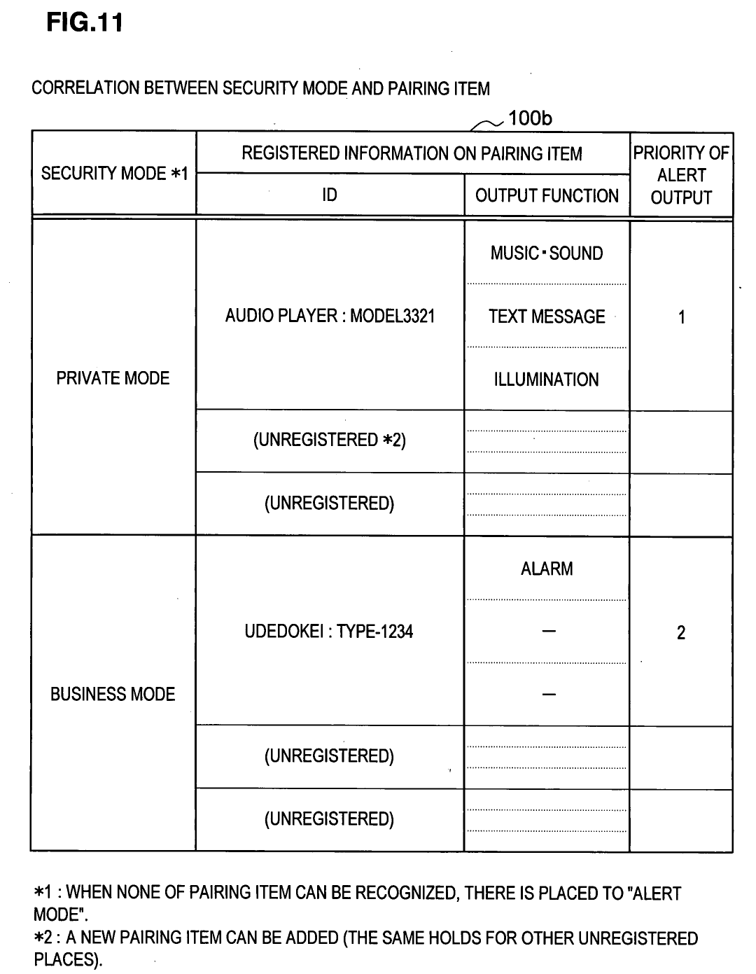

Next, the CPU 100a (registering unit 501) of the mobile-phone 100 sets which pairing items 101, 302 are correlated with each mode of “private mode” and “business mode” to hold in the memory 100b in the mobile-phone 100. FIG. 11 shows the example of the pairing item correlated with each security mode.

<3-5> Normal Using

After the completion of the pairing and setting of security mode, the mobile-phone 100 is placed in the normal use. In this state, the mobile-phone 100 tries to recognize, by using the radio communication means 105 (for example, wireless tag reader or Bluetooth communication) installed in the mobile-phone 100, whether the pairing items 101, 302 exist (whether the peripheral pairing items can be recognized, there is touched for a certain period of time or there has been touched within a certain period of time) when an event is generated (regularly, or at the times of application use/address book data reference/opening flip phone).

According to how many items can be recognized among the types of the items 101, 302 paired in advance, or which item can be recognized, the CPU 100a (operating range determining unit 504) of the mobile-phone 100 switches the mobile-phone 100 itself to the security mode is set as in FIG. 11 to allow the function of the mobile-phone 100 to be used within the set range.

The operation is the same as in the second embodiment so far. The third embodiment is different from the second embodiment in the following point. When the pairing items 101, 302 (for example, without being recognized at all) are placed in “alert mode”, the mobile-phone 100 can output the alert output signals 312, 313 to the pairing items 101, 302 having output function. There will be described later why the alert output signal reaches.

When the CPU 100a (communicating unit 502) of the mobile-phone 100 is placed in “alert mode” and sends the alert output signals 312, 313 to the pairing items 101, 302 by radio, the pairing items 101, 302 having received the alert output signals 312, 313 output an alert (alert alarm 314, alert message 315) to the owner by using the output functions thereof. Then the mobile-phone 100 itself changes the operation of the mobile-phone 100 corresponding to alert reception answer signals 320, 321 (for example, according to that the owner gets close to the mobile-phone 100 or stopped the alarm) as the response to the alert output signals 312, 313.

Next, there will be described changing the operation of the mobile-phone 100. The priority of alert output destination, as shown in FIG. 11, is set in advance for the pairing items 101, 302 having output functions and held in the memory 100b in the mobile-phone 100. First, the mobile-phone 100 is output to the pairing item 302 with higher priority of alert output.

Then, after a certain period of time, when the mobile-phone 100 cannot recognize the pairing item 302 yet or the alert reception answer signal 321 sent from the pairing item 302 in the case the owner has stopped the alert against the alert output signal 313 and so on does not exist, the mobile-phone 100 changes the operation of the mobile-phone 100 itself so that the CPU 100a (communicating unit 502) of the mobile-phone 100 can output the alert output signal 312 to the pairing item 101 with the second highest priority.

The operation as described above is performed sequentially for the item registered as the pairing item in FIG. 11 and having the output function. In addition, when the user notices and gets close to the mobile-phone 100 and stops the alarm, there returns from “alert mode” to “private mode” or “business mode” based on the recognized pairing item. If there are not any answers from all of the pairing items 101, 302, it is possible to perform a final alert operation such as issuing an alert from the mobile-phone 100 itself.

As an example of specific operation, there are following operations (1)-(3).

(1) Since the information on the item 101 of watch is “buzzer sound allowable”, the mobile-phone 100 selects the output method suitable therefor and sends the alert output signal 312. The watch (item 101) having received the signal beeps (alert alarm 314) with a buzzer for alarm embedded in advance.
(2) Since the information on the item 302 of audio player is “sound/music output allowable”, the mobile-phone 100 selects the output method suitable therefor and sends the alert output signal 313 along with the audio data, “mobile-phone is away from you, be careful”. The audio player (item 302) having received the signal interrupts the music listened to by the owner to issue the alert message 315, “mobile-phone is away from you, be careful”.
(3) (Continued from above) since, however, the mobile-phone 100 is still in the state incapable of answering with receipt acknowledgement (sent when the owner stops the alert) corresponding to the alert output signal 313 from the item 302 of audio player or is still in the state incapable of recognizing the audio player, the alert output signal 312 is sent to the watch (item 101) with the second highest priority. With the answer of receipt acknowledgement (indicating that the owner has stopped the alert) (alert reception answer signal 320) in response to this, there returns to “private mode”. In this case, there is a possibility of returning “alert mode” again after a while.

With regard to the above alert operation, further in this embodiment, when the pairing items 101, 302 receive the alert output signal from the mobile-phone 100, the pairing items may keep issuing the alert autonomously by upgrading the function of pairing items even when the mobile-phone 100 becomes away completely.

(Why Alert Output Signal Reaches)

The alert output signal is sent when the mobile-phone 100 cannot recognize the pairing item. However, when the pairing item is distanced from the mobile-phone 100 so that the mobile-phone 100 cannot recognize the pairing item, the pairing item cannot receive the alert output signal from the mobile-phone 100 either. This problem can be solved by the following method.

In other words, when the mobile-phone 100 recognizes the pairing item using information acquisition not with radio wave output of 100% but, for example, with low-power degree of radio wave output of 50% normally. Only when the mobile-phone 100 is too distanced to recognize, the mobile-phone 100 sends the alert output signal to the pairing item at radio wave output of 100%. In the normal state, for example, although the pairing item cannot be recognized at the distance of 3 m, the alert output signal can reach the distance of 10 m in “alert mode”. Note that an actual output value is determined by the radio property between the mobile-phone 100 and the pairing item.

(Method of Realizing Proactive Alert)

However, the above method is performed after there is too distanced to recognize, which is an alert as a so-called backward incidence. It is more effective to issue an alert proactively by sensing the sign before there is actually distanced.

As the method of realizing a proactive alert performed from such a point of view, in the case of passive tag where the pairing item answers in response to the radio wave from the mobile-phone 100, the state likely to be placed in “alert mode” is assumed by monitoring the time-oriented change of the minimum level value of the radio wave output capable of recognizing the pairing item.

To measure the present minimum level value of the radio wave output capable of being recognized, there can be judged by powering down the radiowave output in phases to measure the limiting point capable of being recognized. When the minimum level value is increasing, this means that the mobile-phone is being distanced from the pairing item.

In the case of active tag where the pairing item outputs the radio wave, the state likely to be placed in “alert mode” is assumed by monitoring the level of input radio wave output from the pairing item and received by the mobile-phone.

According to the third embodiment as described above, in addition to the advantage described in the second embodiment, even when the mobile-phone is distanced from the owner, an alert message can be sent from the mobile-phone to the owner. Accordingly, “leaving” itself leading to information leakage can be prevented and the information leakage can be reduced.

In addition, since the output function of the pairing item can be recognized and used by the mobile-phone, the necessity of individual setting to select the output method of alert output signal according to the specific item is eliminated to enhance usability as well.

### Fourth Embodiment

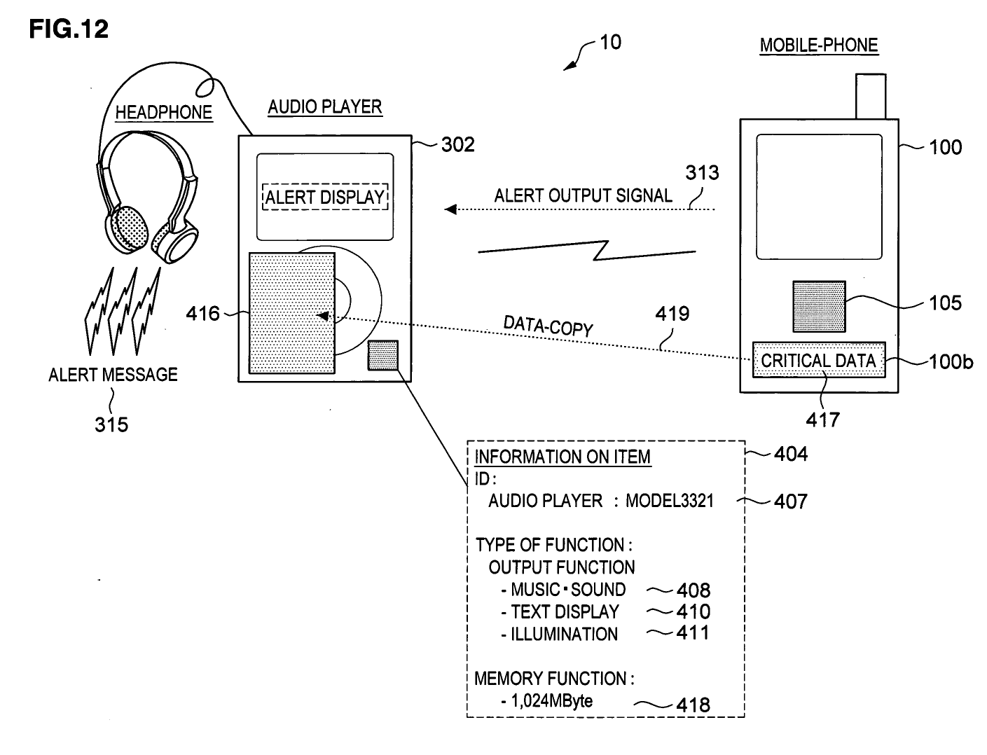

In the next, the fourth embodiment will be described in reference to FIG. 12. The fourth embodiment is different from the third embodiment in the following point. In the case where the pairing item has a function of memory, the critical data in the mobile-phone is copied or rolled out to the pairing item regularly or upon the generation of a certain event. In this embodiment as described above, there is provided a method of extending the function of mobile-phone (i.e., providing the mechanism of backup function for the data in mobile-phone), in addition to switching the security operation in mobile-phone mentioned above.

Here, copying data to the pairing item means backing up data from mobile-phone to the memory of pairing item, and rolling out to the pairing item means that critical data is not left in the mobile-phone and the data is moved to the pairing item from the mobile-phone. However, the destination of copying or rolling out data does not necessarily have to be the pairing item and what always kept on one more often than the mobile-phone may be the destination of copying or rolling out data.

<4-1> Mobile Terminal

In FIG. 12, the mobile-phone 100 is exemplified as the mobile terminal. In the third embodiment, the alert output signal is sent wirelessly from the mobile-phone 100 to the pairing item and the alert is outputted from the pairing item to the owner. In the fourth embodiment, the following function is added. The pairing item 302 has memory 416 and the critical information stored in the memory 100b in the mobile-phone 100 is copied (data-copy 419) or rolled out (deleted from the mobile-phone 100 after copied) to the memory 416 of the pairing item 302.

<4-2> Pairing Item

In FIG. 12, pairing item will be exemplified by an audio player. In the pairing item 302, the information 404 on item that can be acquired by the mobile-phone 100 by the radio communication means 105 (for example, wireless tag reader or Bluetooth communication) mentioned above (described in <3-1> and <4-1>) is stored.

In the fourth embodiment, in the information 404 on item information 418 on memory capacity such as “memory function available”, “1,024 MByte” is stored as the information on the function of the memory 416 included in the pairing item 302 in the information 404 on item, as well as an ID 407 and information on output functions 408, 410, 411 stored in the third embodiment.

This information 418 on memory capacity is assumed to be capable of being acquired by the mobile-phone 100 simultaneously with the aforementioned information 408, 410, 411. The pairing item 302 has a function of receiving the data from the mobile-phone 100 and storing in the memory 416 in the pairing item.

<4-3> Pairing

Next, the pairing method in this embodiment will be described. The method for placing the mobile-phone itself in a pairing mode is not regulated here, similarly to the third embodiment. In the fourth embodiment, as in the third embodiment, only when the mobile-phone recognizes the pairing item, the pairing is performed so as to allow the use of the specific function of the mobile-phone.

The mobile-phone 100 acquires the information 404 on the item of the pairing item 302 to set the output method of the alert output signal 313 suitable for the pairing item 302. Further, since the information 418 on memory function is stored, it is recognized that the memory 416 can be used.

The pairing item is added or deleted as required. The item to be paired with the mobile-phone 100 does not necessarily have to be one for one mobile-phone. A plurality of items can be registered as the pairing item and held in the mobile-phone 100.

<4-4> Security Mode Setting

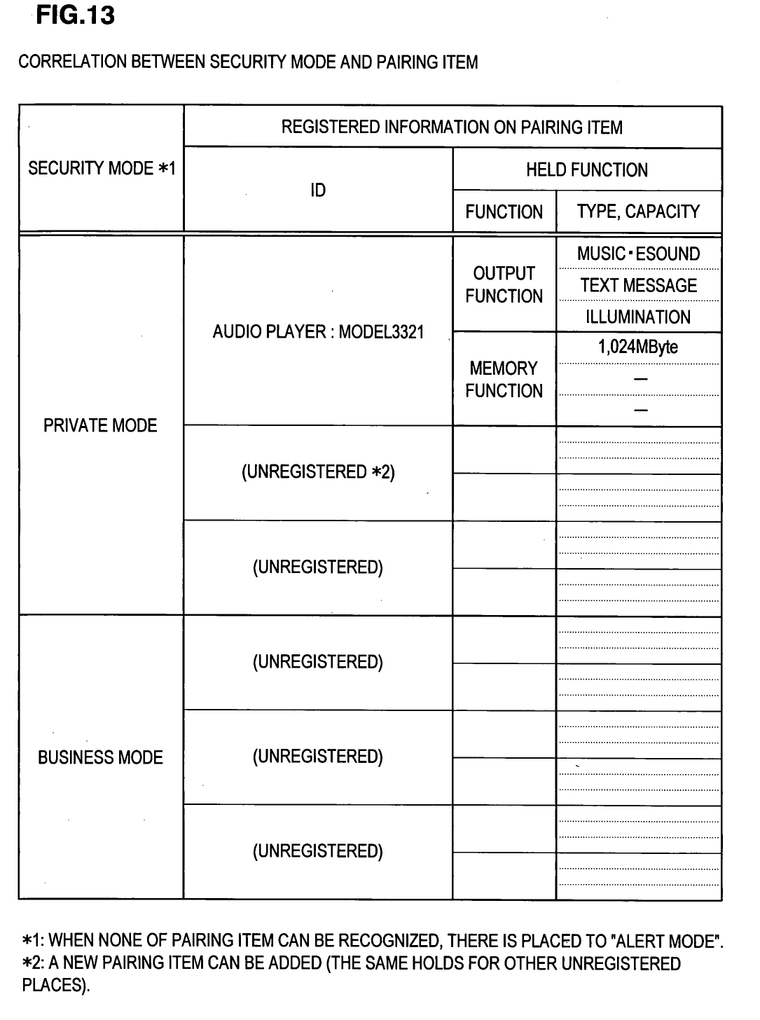

In the fourth embodiment, there are stored in the mobile-phone 100 the information correlated with the security mode and the function of the mobile-phone shown in FIG. 7 and the information correlated with the security mode and the pairing item shown in FIG. 13. In the example of FIG. 13, however, when the audio player is recognized, the mobile-phone 100 operates in the private mode. In addition, the functions (output function, memory function) of each item, and the types and capacity thereof are acquired by pairing and held.

<4-5> Normal Using

After the completion of the pairing and setting of security mode, the mobile-phone 100 is placed in the normal use. In this state, the mobile-phone 100 tries to recognize, by using the radio communication means 105 (for example, wireless tag reader or Bluetooth communication) installed in the mobile-phone 100, whether the pairing item 302 exists (whether the peripheral pairing items can be recognized, there is touched for a certain period of time or there has been touched within a certain period of time) when an event is generated (regularly, or at the times of application use/address book data reference/opening flip phone).

According to how many items can be recognized among the types of the items paired in advance, or which item can be recognized, the mobile-phone 100 is switched to the security mode set in FIG. 13 to be allowed to use the function within the set range.

The operation is the same as in the third embodiment so far. The fourth embodiment is different from the third embodiment in the following point in which the following function is added. When the pairing item 302 has the memory 416, the critical information stored in the memory 100b of the mobile-phone 100 is subject to the data-copy 419 or rolled out (deleted from the mobile-phone after copied) to the memory 416 of the pairing item 302. The example of the detail operation will be explained as below.

For example, when there is placed to “alert mode” (without any recognitions of pairing item), the CPU 100a (alerting unit 505) of the mobile-phone 100 outputs the alert output signal 313 to the pairing item 302. In addition, the CPU 100a (communicating unit 502) rolls out the critical data 417 (data-copy 419) (i.e., sensitive information of owner or critical information in company) stored in the memory 100b of the mobile-phone 100 to the memory 416 of the pairing item 302 and can delete the data from the memory 100b in the mobile-phone 100. More specifically, the CPU 100a (communicating unit 502) of the mobile-phone 100 sends the signal including the critical data 417 to the pairing item 302 to delete the data from the memory 100b. A storing unit (not shown) of the pairing item 302, on the other hand, stores the critical data 417 included in this signal in the memory 416.

It should be noted that the critical data in the memory 416 of the pairing item 302 is assumed to be capable of being read out only from the paired mobile-phone 100. Concretely, the critical data is encoded so that only the mobile-phone 100 can read out the encoded critical data by the method in which the data cannot be read out without knowing decoding method.

Here, there has been described the example where the critical data is sent only in the case where the mobile-phone 100 cannot recognize the pairing item. However, by setting in advance the copy to be sent to the pairing item 302 regularly, even when the owner rapidly leaves the mobile-phone 100 (for example, the owner noticed that the mobile-phone 100 was left, but the train has left), the critical data can be prevented from leaking and loss only by automatic deletion of the critical data from the mobile-phone 100.

Also, the critical data in the mobile-phone can be deleted not only automatically but also remotely afterward. Further, the critical data in the pairing item can be automatically deleted if the pairing cannot be performed with the mobile-phone for a certain period of time (for example, several days).

Since “why the alert output signal reaches” and “method of realizing proactive alert” are as described above, the descriptions thereof will be omitted here.

According to the fourth embodiment as described above, in addition to the advantage described in the third embodiment, even when the mobile-phone is distanced from the owner, critical data is copied or rolled out from the mobile-phone to the pairing item and then the data is deleted. Accordingly, leakage/loss of critical data can be prevented due to unexpected loss/robbery/trouble of mobile-phone. As a result, there can be built a secure information storage system (security system 10) with high degree of reliability.

In the above embodiments, the operations in each unit are correlated with each other and can be replaced as a series of operations, considering each correlation. With such a replacement, an embodiment of invention of method can be achieved.

Also, by replacing the above operations in each unit by processings in each unit, an embodiment of program can be achieved. In addition, by storing a program in a storage medium having the program recorded and readable by a computer, an embodiment of a storage medium recorded a program and readable by a computer can be achieved.

Therefore, an embodiment of allowable operating range determining method of portable electronic device can be achieved as an embodiment of allowable operating range determining program. The allowable operating range determining program is performed by a computer. The allowable operating range determining program of portable electronic device making a computer perform radio communication with an item as a possession other than the portable electronic device owned by an owner of the portable electronic device, the allowable operating range determining program includes registering item information to specify the item in advance in memory, judging, based on the presence or absence of a signal from the item, whether an item specified by the registered item information can communicate with the portable electronic device or not when an event is generated in the portable electronic device, and allowing a normal operation of the portable electronic device in response to an external access when it is judged that the item can communicate with the portable electronic device and limiting the operating range of the portable electronic device in response to an external access when it is judged that the item can not communicate with the portable electronic device. Also, an embodiment of allowable operating range determining method of portable electronic device can be achieved as an embodiment of a storage medium recording this allowable operating range determining program and readable by a computer can be achieved.

It should be noted that each processing in the embodiment of this program and the embodiment of a storage medium recording this program and readable by a computer can be achieved by performing the program by the computer.

Although the preferred embodiment of the present invention has been described referring to the accompanying drawings, the present invention is not limited to such examples. It should be understood by those skilled in the art that various modifications, combinations, sub-combinations and alterations may occur depending on design requirements and other factors insofar as they are within the scope of the appended claims or the equivalents thereof.

For example, the above-described mobile-phone 100 is an example of portable electronic device and the present invention is not limited to this. A mobile device such as digital camera, a digital video camera and a head-mounted display is applicable as well as a PDA (Personal Digital Assistants).

In the third embodiment described above, in addition, although there has been described the pairing between a mobile-phone and an item worn (or carried) by an owner, there is applicable to prevent “leaving/loss of important possession” on the side of the owner carrying the portable electronic device by pairing the “portable electronic device” and a “wireless tag attached/stuck to an important possession (for example, bag, document, etc.)”.

In the first-fourth embodiments, in addition, although the possession owned by an owner has been exemplified as the item to be paired with the mobile-phone, the present invention is not limited to this example. When the owner owns two units of mobile-phones (for example, a mobile-phone and a PDA, or mobile-phones for business and personal uses), these two units can be paired.

### INDUSTRIAL APPLICABILITY

The present invention is applicable to a portable electronic device limiting an allowable operating range thereof to enhance a security and a security system using the portable electronic device.

What is claimed is:

1. A portable electronic device radio communicating with an item as a possession other than the portable electronic device owned by an owner of the portable electronic device, the portable electronic device comprising:
a registering unit for registering item information for specifying the item in advance in memory;
a judging unit for judging, based on the presence or absence of a signal from the item, whether an item specified by the registered item information can communicate with the portable electronic device or not when an event is generated in the portable electronic device; and
an operating range determining unit for allowing a normal operation of the portable electronic device in response to an external access when the judging unit judges that the item can communicate with the portable electronic device, and for limiting the operating range of the portable electronic device in response to an external access when the judging unit judges that the item can not communicate with the portable electronic device.

2. The portable electronic device according to claim 1 wherein the operating range determining unit bans the operation of the portable electronic device in response to an external access when it is judged that the item can not communicate with the portable electronic device.

3. The portable electronic device according to claim 1 wherein the operating range determining unit bans the operation other than the operation according to an urgent message of the portable electronic device in response to an external access when it is judged that the item can not communicate with the portable electronic device.

4. The portable electronic device according to claim 1 wherein:
the registering unit registers the item information in memory as being related to at least one of a plurality of functions included in the portable electronic device; and
the operating range determining unit allows the operation of the portable electronic device corresponding to a function related to the item information among the plurality of functions included in the portable electronic device when it is judged that the item can communicate with the portable electronic device.

5. The portable electronic device according to claim 1 wherein the judging unit judges that the portable electronic device can communicate with the item when the portable electronic device is in the state where it is possible to communicate with the item for a certain period of time or longer.

6. The portable electronic device according to claim 1 wherein the operating range determining unit allows the operation of the portable electronic device in response to an external access within a certain period of time after it is judged that the item can communicate with the portable electronic device.

7. The portable electronic device according to claim 1 wherein:
the registering unit provides modes indicating the allowable range of the use of function in phases among the plurality of functions included in the portable electronic device and registers the item information in memory in relation to each of the modes provided in phases; and
the operating range determining unit allows the operation of the portable electronic device according to a function corresponding to the modes related to the item information when it is judged that the item can communicate with the portable electronic device, and allows the operation of the portable electronic device according to a predetermined minimum operation when it is not judged that the item specified by the item information can communicate with the portable electronic device.

8. The portable electronic device according to claim 7 wherein the portable electronic device further comprising:
a communicating unit for sending an alert output signal to the item when the operating range determining unit allows the operation of the portable electronic device according to a minimum function.

9. The portable electronic device according to claim 1 wherein:
the registering unit registers the item information in memory to specify a plurality of items as a possession other than the portable electronic device; and
the operating range determining unit allows the normal operation of the portable electronic device in response to an external access when the judging unit judges that at least one of the plurality of items can communicate with the portable electronic device and limits the operating range of the portable electronic device in response to an external access when the judging unit judges that none of the items can communicate with the portable electronic device.

10. The portable electronic device according to claim 9 wherein:
the registering unit registers a priority in memory to send the alert output signal in relation to the plurality of item information registered; and
the communicating unit sends the alert output signal to the item specified by the registered item information with higher priority sequentially.

11. The portable electronic device according to claim 8 wherein the operating range determining unit allows the operation of the portable electronic device according to a function corresponding to the modes related to the item information when a signal from the item is received in response to the sent alert output signal.

12. The portable electronic device according to claim 8 wherein the portable electronic device further comprising:
an alerting unit for issuing an alert with the portable electronic device itself when a signal from the item is not received in response to the sent alert output signal.

13. A portable electronic device radio communicating with an item as a possession other than the portable electronic device owned by an owner of the portable electronic device, wherein the portable electronic device:
judges, based on the presence or absence of a signal from the item, whether an item specified by a registered item information can communicate with the portable electronic device or not when an event is generated in the portable electronic device; and
performs so as to enhance the security of the portable electronic device by using a function for improving the security provided in the item when it is judged that the item can communicate with the portable electronic device.

14. The portable electronic device according to claim 13 wherein the portable electronic device sends a signal including predetermined critical data registered in memory of the portable electronic device at a predetermined timing, so as to store the critical data in memory provided in the item.

15. A security system having a portable electronic device connected by radio with an item as a possession other than the portable electronic device owned by an owner of the portable electronic device, the portable electronic device comprising:
a registering unit for registering item information for specifying the item in advance in memory;
a judging unit for judging, based on the presence or absence of a signal from the item, whether an item specified by the registered item information can communicate with the portable electronic device or not when an event is generated in the portable electronic device; and
an operating range determining unit for allowing a normal operation of the portable electronic device in response to an external access when the judging unit judges that the item can communicate with the portable electronic device, and for limiting the operating range of the portable electronic device in response to an external access when the judging unit judges that the item can not communicate with the portable electronic device.

16. A security system having a portable electronic device connected by radio with an item as a possession other than the portable electronic device owned by an owner of the portable electronic device, wherein:
the item includes a function for enhancing a security; and
the portable electronic device,
judges, based on the presence or absence of a signal from the item, whether an item specified by the registered item information can communicate with the portable electronic device or not when an event is generated in the portable electronic device, and
performs so as to enhance the security of the portable electronic device by using a function for improving the security provided in the item when it is judged that the item can communicate with the portable electronic device.

17. The security system according to claim 15 wherein the portable electronic device, by sending an alert output signal to the item, uses an alerting function as a function for improving the security provided in the item to generate an alert according to the sent alert output signal in the item when it is judged that the item specified by the item information can not communicate with the portable electronic device.

18. The security system according to claim 16 wherein the portable electronic device, by sending an alert output signal to the item, generate an alert according to the sent alert output signal in the item using an alerting function as a function for improving the security provided in the item when it is judged that the item specified by the item information can not communicate with the portable electronic device.

19. The security system according to claim 16 wherein the portable electronic device, by sending a signal including predetermined critical data registered in the memory of portable electronic device at a predetermined timing, store the critical data included in the sent signal in memory provided in the item using a storing function as a function for improving the security.

20. An allowable operating range determining method of portable electronic device radio communicating with an item as a possession other than the portable electronic device owned by an owner of the portable electronic device, the allowable operating range determining method comprising:
registering item information to specify the item in advance in memory;
judging, based on the presence or absence of a signal from the item, whether an item specified by the registered item information can communicate with the portable electronic device or not when an event is generated in the portable electronic device; and
allowing a normal operation of the portable electronic device in response to an external access when it is judged that the item can communicate with the portable electronic device, and limiting the operating range of the portable electronic device in response to an external access when it is judged that the item can not communicate with the portable electronic device.
